(19) United States
(12) Patent Application Publication
(10) Pub. No.: US 2016/0314507 A1
(43) Pub. Date: Oct. 27, 2016

(54) APPARATUS, SYSTEM, AND METHOD FOR RANKING AND DELIVERY OF PERSONALIZED PRODUCT REVIEWS

(71) Applicant: Product Peel, Inc., Union City, CA (US)

(72) Inventors: Patrick Tedjamulia, Union City, CA (US); Gustavo Soares, Union City, CA (US); Maria Tedjamulia, Union City, CA (US); Roy Terry, Union City, CA (US); Aaron Hill, Union City, CA (US); Alisha Provstgaard, Union City, CA (US)

(21) Appl. No.: 15/135,513

(22) Filed: Apr. 21, 2016

Related U.S. Application Data
(60) Provisional application No. 62/151,333, filed on Apr. 22, 2015.
(60) Provisional application No. 62/305,860, filed on Mar. 9, 2016.

(51) Int. Cl. G06Q 30/02; G06F 17/30

(52) U.S. Cl. CPC G06Q 30/0282; G06F 17/3053

(57) ABSTRACT

An access request by a user of a client device is identified. Context of a feedback on a product or service is established. A relevance of the feedback to the user is determined based on the context of the feedback, and the feedback is selected for delivery to the client device based on the relevance to the user.

### CROSS-REFERENCE TO RELATED APPLICATIONS

This application claims the benefit of U.S. Provisional Application No. 62/151,333, filed on Apr. 22, 2015, and the benefit of U.S. Provisional Application No. 62/305,860, filed on Mar. 9, 2016, the contents of which are incorporated herein by reference in their entireties.

### TECHNICAL FIELD

This disclosure generally relates to ranking and delivery of personalized product reviews and viewing of such personalized product reviews.

### BACKGROUND

Today's product reviews have made products too impersonal. Products are not just numbers. Products are not just 3 stars or 5 stars. Products are about people who use or might use such products. To truly understand a product, it is desirable to understand people who use the product and what they are experiencing throughout the lifecycle of the product. Once a product is understood at a personal level, one can discover what is possible with the product. For example, one can discover why the product was created, who the product works well for and who it does not work well for, what the product can do, and what could make the product better.

It is against this background that a need arose to develop the embodiments described in this disclosure.

### SUMMARY

In some embodiments, a system includes a processor, a memory connected to the processor, and the memory stores instructions executable by the processor to: (1) identify an access request by a user of a client device; (2) establish context of a feedback on a product or service; (3) determine a relevance of the feedback to the user based on the context of the feedback; and (4) select the feedback for delivery to the client device based on the relevance to the user.

In some embodiments, establishing the context of the feedback includes identifying attributes of a contributor of the feedback.

In some embodiments, the attributes of the contributor include at least one of demographics, education, profession, interests, relationships, or geography of the contributor.

In some embodiments, the feedback is indicative of a positive or negative experience with the product or service, and establishing the context of the feedback includes identifying shared attributes of persons who have the same experience with the product or service.

In some embodiments, establishing the context of the feedback includes identifying a timeliness of the feedback.

In some embodiments, establishing the context of the feedback includes identifying a number of user interactions with the feedback.

In some embodiments, the memory further stores instructions executable by the processor to establish context of the user, and determining the relevance of the feedback includes calculating a relevance score based on matching the context of the user and the context of the feedback.

In some embodiments, the memory further stores instructions executable by the processor to deliver the feedback for display at the client device, and the feedback includes at least one of an image, audio, a video, or text.

In some embodiments, the feedback includes a sequenced set of slides viewable by the user in response to triggering a navigation element.

In some embodiments, the sequenced set of slides includes a first slide and a second slide, and the second slide is displayed in place of the first slide in response to triggering the navigation element.

In some embodiments, the navigation element is a forward navigation element, and the first slide is displayed in place of the second slide in response to triggering a backward navigation element.

In some embodiments, the memory further stores instructions executable by the processor to establish permission to the user to add content to the feedback, and incorporate additional content contributed by the user into the feedback.

In some embodiments, content of the feedback is editable by a contributor of the feedback.

In some embodiments, the memory further stores instructions executable by the processor to establish context of a reply to the feedback contributed by the user, and establish a link between the feedback and the reply.

In further embodiments, a system includes a processor, a memory connected to the processor, and the memory stores instructions executable by the processor to: (1) identify an access request by a client device; and (2) deliver a feedback on a product or service for display at the client device, the feedback includes a recommendation status, a set of navigation elements, and a sequenced set of slides viewable in response to triggering the set of navigation elements.

In some embodiments, the set of navigation elements includes a forward navigation element, the sequenced set of slides includes a first slide and a second slide, and the second slide is displayed in place of the first slide in response to triggering the forward navigation element.

In some embodiments, the set of navigation elements further includes a backward navigation element, and the first slide is displayed in place of the second slide in response to triggering the backward navigation element.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1 shows a screenshot of an example homepage in which a user can access functionality of a product review ranking and delivery system of some embodiments of this disclosure.

FIG. 2 shows a screenshot of an example product category page upon selection of a camera accessories category, according to some embodiments of this disclosure.

FIG. 3 shows a screenshot of an example product page upon selection of a particular camera product, according to some embodiments of this disclosure.

FIG. 4 shows a screenshot of an example user's profile page of some embodiments of this disclosure.

FIG. 5 shows an example screenshot of peeling a product, according to some embodiments of this disclosure.

FIG. 6, FIG. 7, and FIG. 8 show example screenshots of viewing various slides of a peel, according to some embodiments of this disclosure.

FIG. 9 shows an example screenshot of contributing a peel on a product, according to some embodiments of this disclosure.

FIG. 10 shows an example screenshot of a peel of a product, and FIG. 11 shows an example screenshot of editing the peel of the product, responsive to user selection of an Edit option in FIG. 10, according to some embodiments of this disclosure.

FIG. 12 shows an example screenshot of a product peel, which includes user interface elements to allow selection of Reply and Share options, according to some embodiments of this disclosure.

FIG. 13 shows an example screenshot of replying to a product peel, according to some embodiments of this disclosure.

FIG. 14 shows a screenshot of an example homepage in which a user can add a product to be peeled, according to some embodiments of this disclosure.

FIG. 15 shows an example screenshot of adding a product, according to some embodiments of this disclosure.

FIG. 16 shows an example screenshot of matching a user entered product name with that of an existing product, according to some embodiments of this disclosure.

FIG. 17 is an example block diagram representation of functionality of a product review ranking and delivery system of some embodiments of this disclosure.

FIG. 18 is a representation of an example of a network environment in which the product review ranking and delivery system of some embodiments can be implemented.

FIG. 19 shows an example of a computing device, according to some embodiments of this disclosure.

### DETAILED DESCRIPTION

By way of overview, some embodiments of this disclosure are directed to a product review ranking and delivery system (referred to as The Product Experience Network™ in some embodiments) that can make product reviews personal so that product reviews that are more relevant for a first user can be delivered to that first user, product reviews that are more relevant for a different, second user can be delivered to that second user, and so on. By personalizing product reviews in such manner, users can better determine if a product is right for them, and discover what is possible with the product. In some embodiments, the system specifies that contributors of product reviews identify themselves and provide context as part of submitting their feedback on a product. By establishing context for a product review in such manner, the system can identify other users who might share similar context and for which the product review might be more relevant. Establishing context can be achieved in several ways, and further details are provided below.

Additionally, a product review ranking and delivery system of some embodiments establishes and organizes product reviews as product peels to allow users to more fully understand a product as part of making a purchasing decision. Multiple contributions by the same user or different users can be linked together in a common peel to form a continuous story of time-sequenced feedback on a product. Accessing multiple contributions to a peel can be analogized to peeling layers of an object, and peeling a product allows a user to evaluate if the product is right for that user and discover what is possible with the product. In some embodiments, a peel can include visual (or audiovisual) content in the form of one or more of an image, audio, and a video, along with textual content, such that users can readily view actual experiences of other users with a product, rather than relying solely on reading textual product reviews. The system of some embodiments provides a centralized hub where users can share product reviews, contribute product reviews, edit product reviews, collaborate on product reviews, and access product reviews from other users similar to them. Furthermore, the system provides scalability to expand access to its functionality through third party entities, such as websites of retailers, publishers, or other entities affiliated with product brands, while retaining a centralized hub that aggregates, organizes, and allows voting or other interactions on product reviews in order to determine more relevant feedback for delivery to users.

Although some embodiments are explained in the context of products or product reviews, it should be understood that embodiments of this disclosure are generally applicable to any merchandise, which refers to any product or service that may be subject to a commercial transaction. A product can be a tangible product, a digital product, an intellectual property, a real property, or an entity, for example. A service can be a conventional service or a digital service, for example. More generally, embodiments of this disclosure can be extended to reviews of places, people, events, campaigns, entities, and so forth.

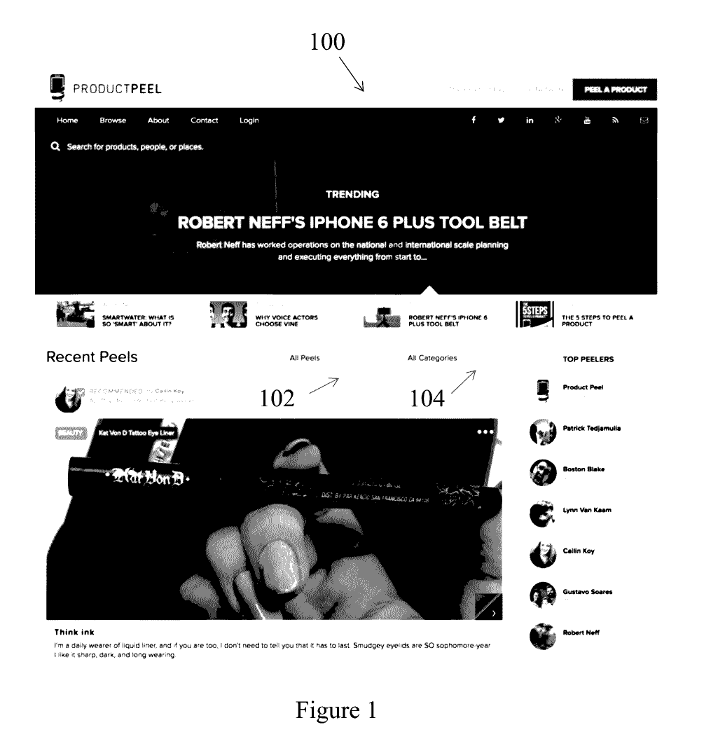

FIGS. 1 through 16 below show example screenshots of a user interface that can be provided by a product review ranking and delivery system of some embodiments of this disclosure.

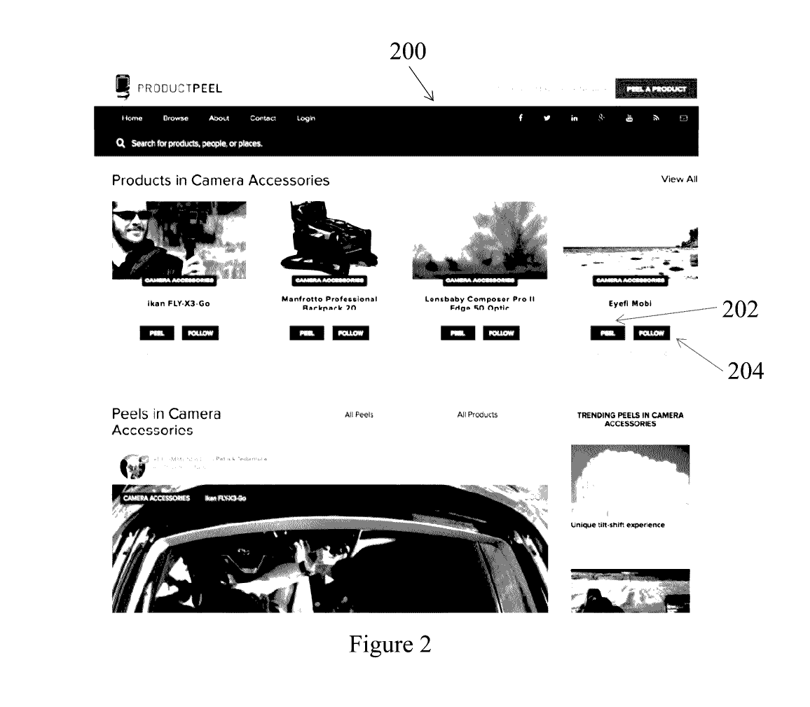

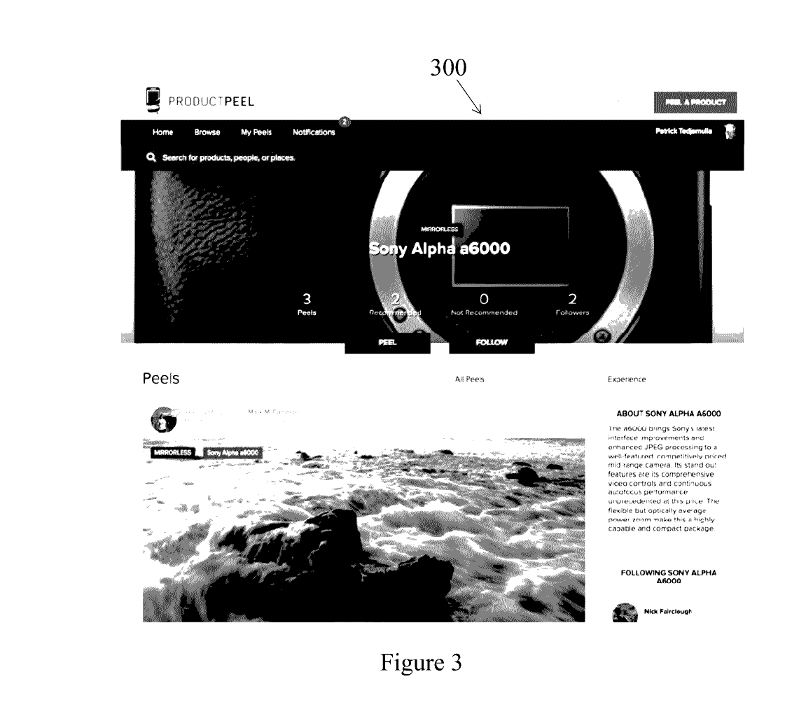

FIG. 1 shows a screenshot of an example homepage 100 in which a user can access functionality of the system, such as in response to an access request at a client device. As shown in FIG. 1, the homepage 100 allows the user access to product reviews, which are organized along multiple product categories of, for example, Camera Accessories, Fitness, Automotive, and so forth, and are further organized along multiple products under each product category. The product categories are provided by way of example, and other product categories can be included or customized according to the user's interests. The homepage 100 allows the user access to product reviews as optionally filtered by user-specified selection of a particular product (through a drop-down list 102) or a particular product category (through a drop-down list 104). FIG. 2 shows a screenshot of an example product category page 200 upon selection of a camera accessories category, and FIG. 3 shows a screenshot of an example product page 300 upon selection of a particular camera product.

For each product, such as a product under the camera accessories category, reviews for the product are organized as peels of the product, some of which can be linked together in a common peel to form a continuous story of time-sequenced feedback on the product. As shown in FIG. 2, user interface elements, such as in the form of radio buttons 202 and 204, allow user specification of whether to start providing feedback on a product (by peeling the product), and whether to follow or unfollow a product. As shown in the camera product page of FIG. 3, the number of feedbacks (number of peels) available for viewing for the product, the numbers of users recommending and not recommending the product, and the number of users following the product are indicated. As part of accessing product reviews, the product review ranking and delivery system can request that the user identify himself or herself and provide context so that the system can identify product reviews from other users who might share similar context and who contributed product reviews that are more relevant based on shared context. In turn, the system can direct product reviews to be displayed in a ranked order according to relevance to the user, with the more relevant feedbacks higher in the ranked order than less relevant feedbacks.

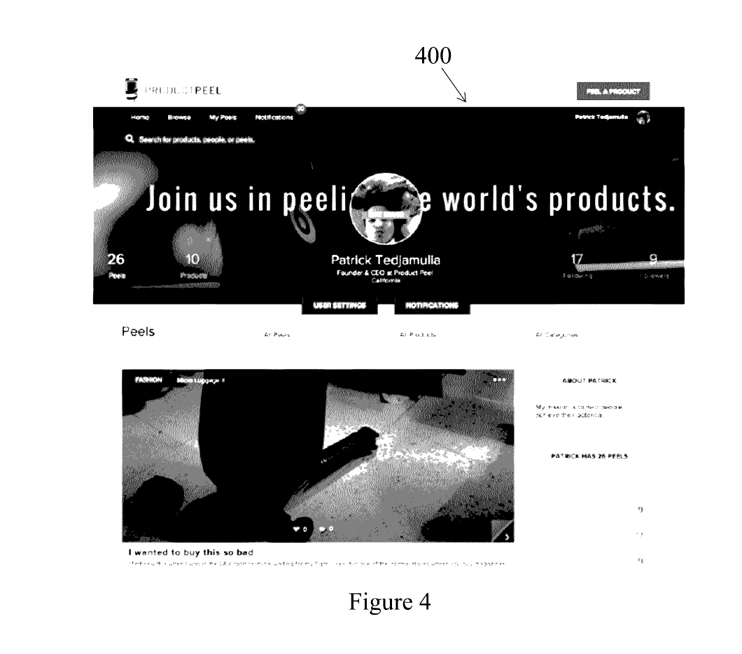

In addition to allowing the user to view product reviews, the product review ranking and delivery system provides access to other functionality that allows the user to interact with product reviews, such as sharing product reviews with other users, following other users might share similar context, following products of interest to the user, voting on product reviews based on how relevant or helpful are the reviews, and other manner of interaction. Furthermore, the system allows the user to contribute a product review, such as by starting a new peel of a product or adding or replying to the peel, or to a peel of another user, and the system establishes context for the product review, by requesting that the user identify himself or herself and provide context as part of submitting feedback on a product or replying to feedback. As shown in a user's profile page of FIG. 4, the number of feedbacks (number of peels) contributed by the user, the number of products peeled or followed by the user, the number of other users that the user is following, and the number of other users following the user are indicated.

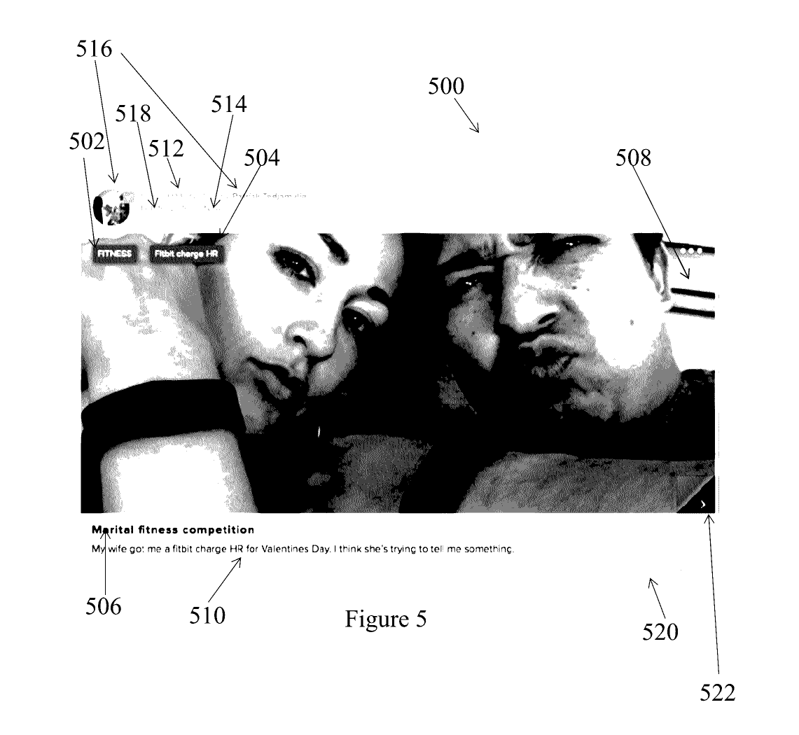

FIG. 5 shows an example screenshot of peeling a product. As shown in FIG. 5, a peel 500 of some embodiments includes the following components: 1) an indication 502 of a product category (here, a Fitness category), 2) an indication 504 of a product being peeled (here, fitbit charge HR), 3) a title 506, which is a user response solicited by the product review ranking and delivery system (here, Marital fitness competition), 4) a presentation element 508 including one or more images, audio, or videos indicative of a contributor's experience with using the product, 5) a textual comment 510 in which a contributor of the peel shares his or her experience with the product, 6) a recommendation status 512 (recommended or not recommended), 7) an experience level 514 of using the product (such as in terms of an extent of usage of the product, whether a quantitative metric or other metric along a scale like New, Intermediate, Advanced, Considering, and No Longer Using), and 8) a user icon and name 516 of the contributor of the peel. As shown in FIG. 5, the peel 500 also includes an indication 518 of when a feedback was contributed, as a measure of timeliness of the feedback, as well as indications 520 of the number of votes on the peel 500 as relevant or helpful, the number of instances of additions or replies to the peel 500, and the number of instances in which the peel 500 has been shared.

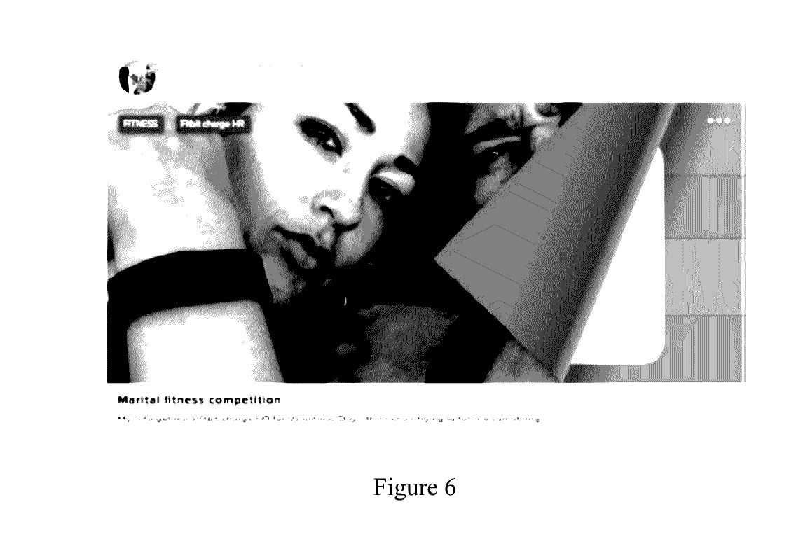

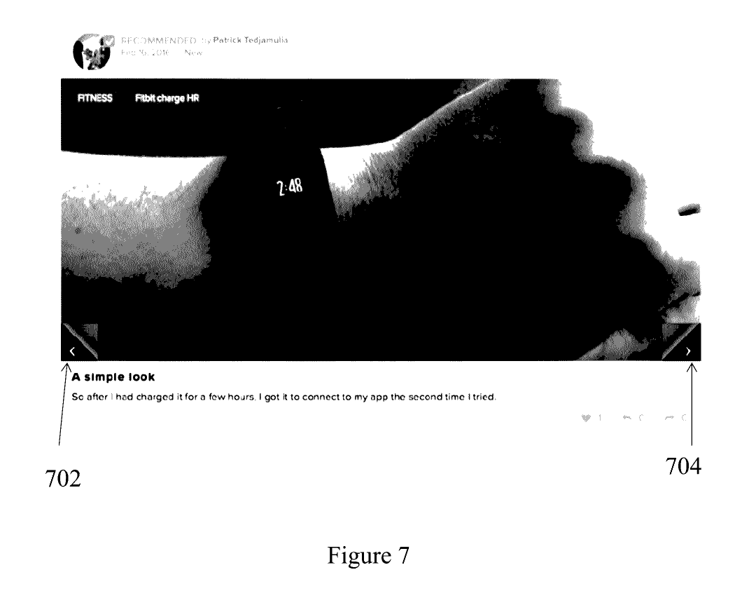

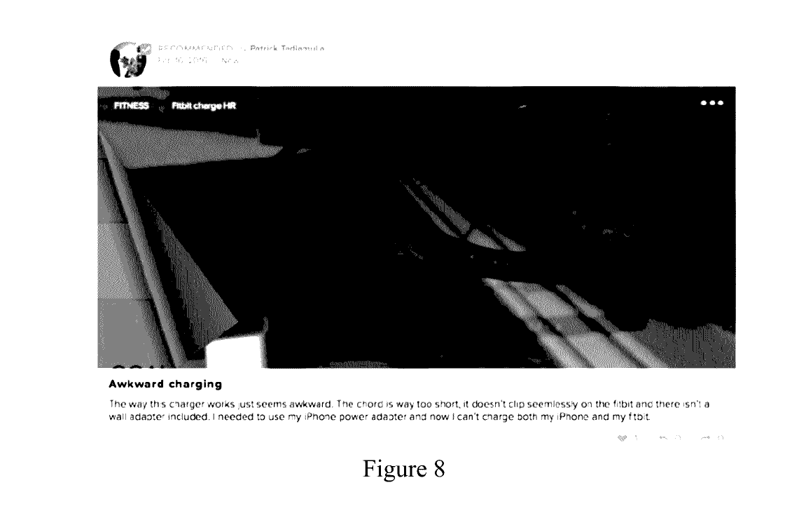

In some embodiments, a peel is a dynamic object having content that can be updated over time. Rather than an one-time post that remains static or having static content, a user can convey an evolving story of feedback on a product through his or her contributed peel by adding to the peel or editing the peel. Also, other users can collaborate on the peel, by adding or replying to the peel to share feedback on the same product. Each additional contribution to the peel is akin to adding another slide to the peel, where the added slide can include an image, audio, or a video, along with textual content, and, along with other contributions to the peel, can form a sequence of slides that can be viewed when peeling a product. Referring to FIG. 5, a user experience in viewing the peel 500 operates as an animation where clicking or hovering a cursor over a forward navigation element 522 (or otherwise triggering the forward navigation element 522) on a right side of one slide of the peel 500 (one peel image) turns over the slide to display a next slide of the peel (next peel image), as shown in example screenshots of FIGS. 6 and 7. Textual content below the peel image also changes to match textual content associated with the next peel image.

Similarly, clicking or hovering a cursor over a backward navigation element (or otherwise triggering the backward navigation element) on a left side of one slide of the peel (one peel image) turns over the slide to display a previous slide of the peel (previous peel image), as shown in the example screenshot of FIG. 8. Textual content below the peel image also changes to match textual content associated with the previous peel image. Referring back to FIG. 7, a particular slide that has contributions before and after the slide is displayed with backward and forward navigation elements 702 and 704 to turn in either direction.

In some embodiments, when a user initially accesses a page from a website of the product review ranking and delivery system, the page is not loaded with peel content. To keep the site dynamic and responsive, peels are loaded using asynchronous JavaScript and XML (AJAX) requests. This way, if there are a multitude of peels, smaller groups of peels (for example, three to six at a time) are loaded until the user scrolls beyond these initially loaded peels and triggers a request to load additional peels.

For each peel, two slides (or another number of slides less than the total number of slides) are loaded on an initial load request; subsequently, if the user clicks to turn to the next slide, remaining slides are loaded. This way, if there are a multitude of slides including images or video, a smaller number of slides are initially loaded until the user clicks to turn to the next slide and triggers a request to load remaining slides. Slides can be loaded responsively for each peel. Previous slides are already loaded such that the user can readily select to return to the previous sides.

In some embodiments, a specific JavaScript generates an AJAX request, returning a JavaScript Object Notation (JSON) object that returns HyperText Markup Language (HTML) content, along with a peels count and featured peels, and another JavaScript component generates an animation when clicking on a peel. A JavaScript plug-in (for example, Turn.js for web application and a custom JavaScript plug-in for mobile application) is used to implement a peeling animation when a user selects to turn to a next slide. The JavaScript plug-in creates a three-dimensional (3D) Cascading Style Sheets (CSS) transformation which yields a user experience akin to peeling away to a next slide. Customizations can be added to the Turn.js JavaScript plug-in, through hooks of the plug-in. For example, when loading a slide, each slide has an associated title and a textual comment, and this content is dynamic based on the slide to yield a user experience akin to reading a story. As another example, additional triggers are added for turning a peel image, which includes clicking on any portion of the image. A right half of the image will turn from right to left, and a left half of the image will turn from left to right. If there are no additional slides, clicking on the image takes the user to the peel's page.

In some embodiments, multiple aspects are involved in peeling a product, such as:

1) the Product Story: to understand an underlying story of the product, who created it, why the product was created, who was it created for, how was it marketed and sold, the issues and feature requests, and how are the issues and feature requests being addressed;

2) the Why: to find out why people similar to a user are buying and using the product;

3) the How: to discover how people use the product, how much time/money is spent on the product, and how long the product will last;

4) the When: to observe when people use the product, where are they using the product, and who are they with; and

5) the What: to determine what impact the product has on people who use the product, what problem does the product solve, and what are people willing to give up in exchange for the product.

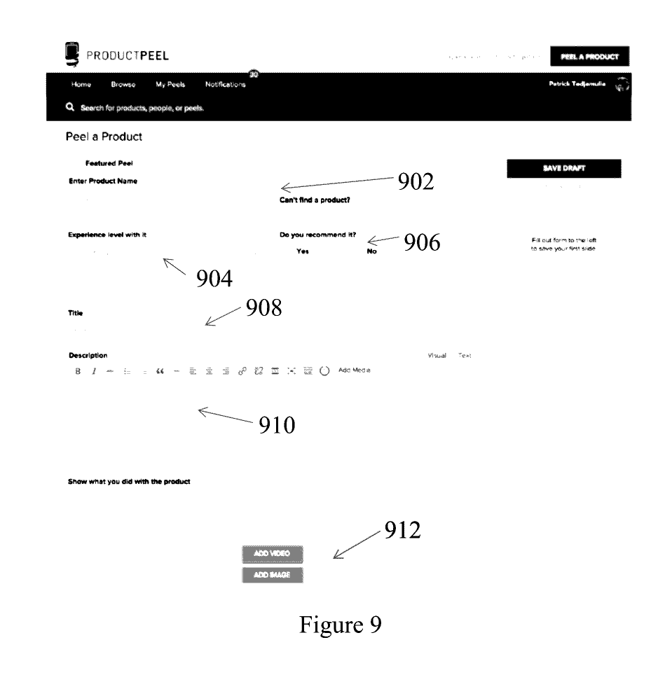

To establish multiple aspects of peeling a product, the product review ranking and delivery system solicits information from contributors of product reviews that translates into components of peels. FIG. 9 shows an example screenshot of contributing a peel on a product. A product name field 902 solicits a response to identify the product being peeled, an experience level field 904 solicits a response regarding an experience level of using the product, recommendation status checkboxes 906 solicit a response regarding a recommendation status of the product, a title field 908 solicits a response regarding a title of the peel, a description field 910 solicits a response regarding a textual comment on experience with the product, and a presentation field 912 solicits an image or a video indicative of a contributor's experience with using the product. Similarly, other fields can be adapted to solicit responses related to other aspects of peeling a product. Also, a title field (or other field) can be adapted according to a third party entity, such as a retailer, a publisher, or other entity affiliated with a product brand, yielding a response specific or tailored to that third party entity.

For example, experience levels can be customized according to particular products provided by particular third party entities. A particular product can have a product experience having various aspects or stages that a user can undergo to realize a full potential of that product. A product experience can be based on one or more of the following: product feature, flavor, duration, occasion, location, achievement, collaboration, and so forth. As an example, a smartphone can have various features including 4K video and 3D Touch. Some users may utilize these features, and others may not. A third party entity affiliated with the smartphone can specify customization of its smartphone experience levels into various product features, therefore allowing contributors to peel in detail on specific product features. And when a contributor peels a specific feature, the contributor can earn a badge for that specific feature. Another example is an article of clothing or other fashion product that can have various possible usage occasions including outings with kids, chores around the home, and outdoor events and celebrations. A third party entity affiliated with the fashion product can specify customization of its product experience levels into these and other occasions, therefore allowing contributors to peel in detail on specific usage occasions. And when a contributor peels a specific occasion, the contributor can earn a badge for that specific occasion. Product experience badges can be customized for a third party entity and assigned to specific product experience levels. Third party entities can select which peels are awarded badges or can specify that all contributors of peels on a specific experience level can receive badges. Third party entities can also select alternatives for badges, such as discounts, promotions, contest entries, giveaways, downloads, and so forth.

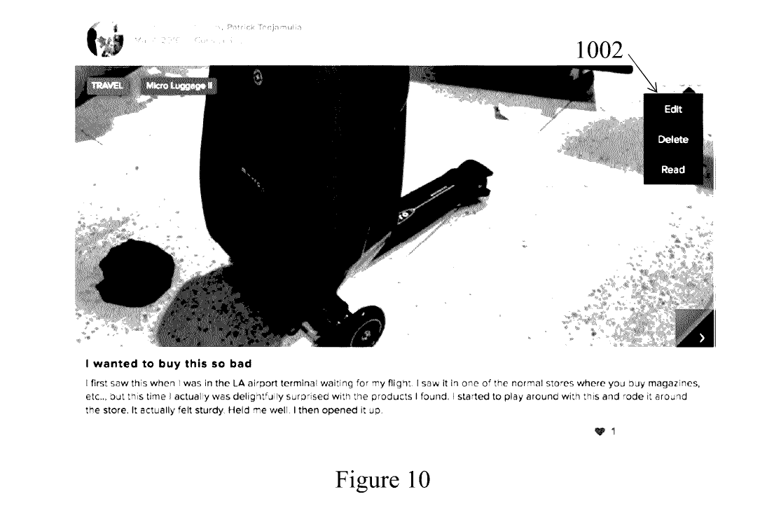

As explained above, a peel of some embodiments is a dynamic object having content that can be updated over time. Rather than an one-time post that remains static or having static content, a user can convey an evolving story of feedback on a product through his or her contributed peel by editing the peel. FIG. 10 shows an example screenshot of a peel of a product, and FIG. 11 shows an example screenshot of editing the peel of the product, responsive to user selection of an Edit option 1002 in FIG. 10. Thus, for example, a user can modify the recommendation status of the peel, or, as the user's experience with the product changes over time, the user can modify his or her experience level with the product.

In addition to viewing feedbacks on a product, a user can engage in other interactions with feedbacks, such as sharing a peel contributed by the user, adding or replying to a peel contributed by another user, tagging other users to allow other users to add to the peel contributed by the user, and other manner of interaction.

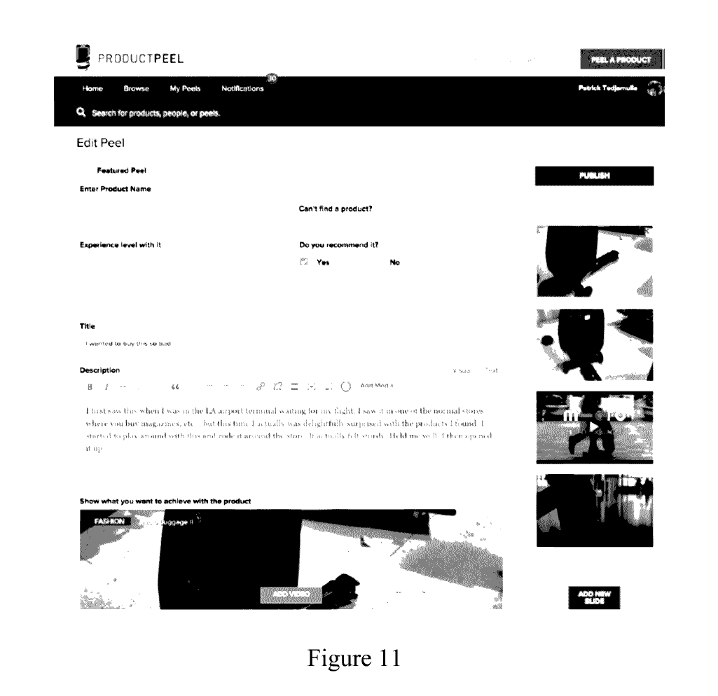

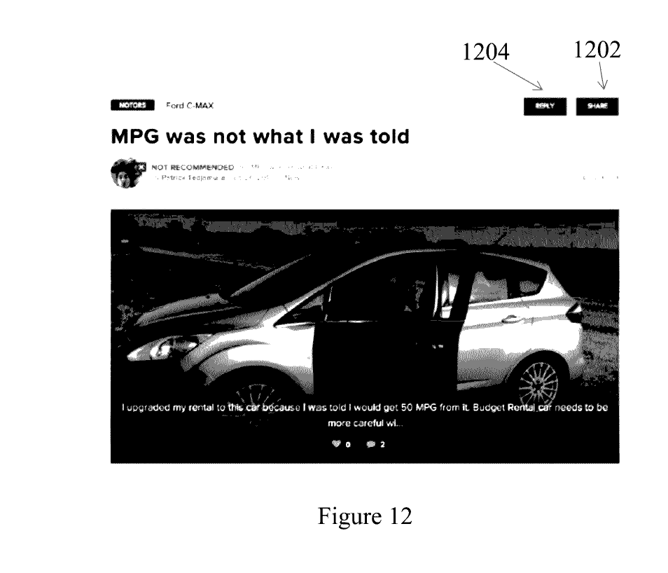

FIG. 12 shows an example screenshot of a product peel, which includes user interface elements to allow selection of Reply and Share options. Users viewing the peel can click on a Share button 1202, and share the peel on social media (for example, Facebook, Twitter, and so forth) or via electronic-mail. When sharing the peel, the title of the peel and a specific slide of the peel are displayed in that share.

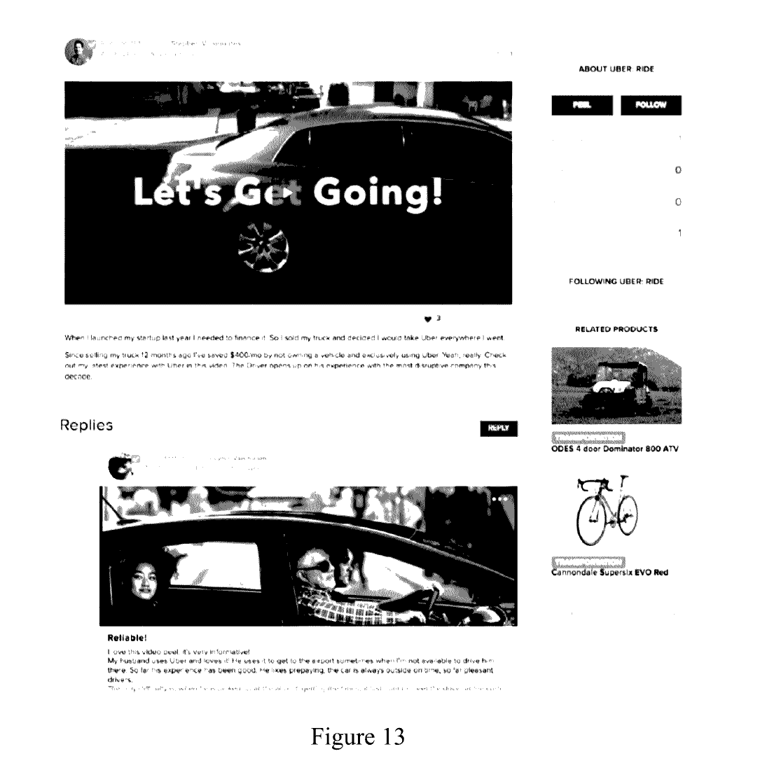

Also, a user viewing the peel can click on a Reply button 1204, and reply to the peel by adding another peel, which can include a textual comment, or can also include an image or a video. FIG. 13 shows an example screenshot of replying to a product peel. Replies can be submitted by any logged-in user of the product review ranking and delivery system, but the system can solicit that a reply includes a recommendation status and an experience level with a product to maintain consistency of content throughout peels. The system can identify the reply as related to the peel, and can establish a link between the reply and the peel.

Further, a user can tag other users who will receive notifications inviting them and giving them or otherwise establishing permission to add to a peel contributed by the user. This is different than replying to a peel, as tagged users can add slides to an existing peel, rather than contributing additional or separate peels. This way, multiple users can collaborate on a common peel, and can share experiences on a product together with other users.

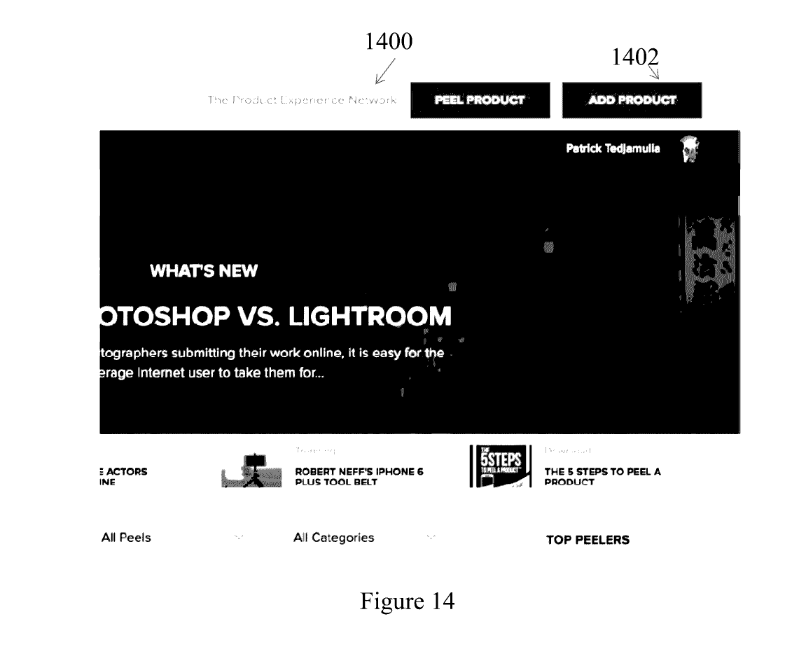

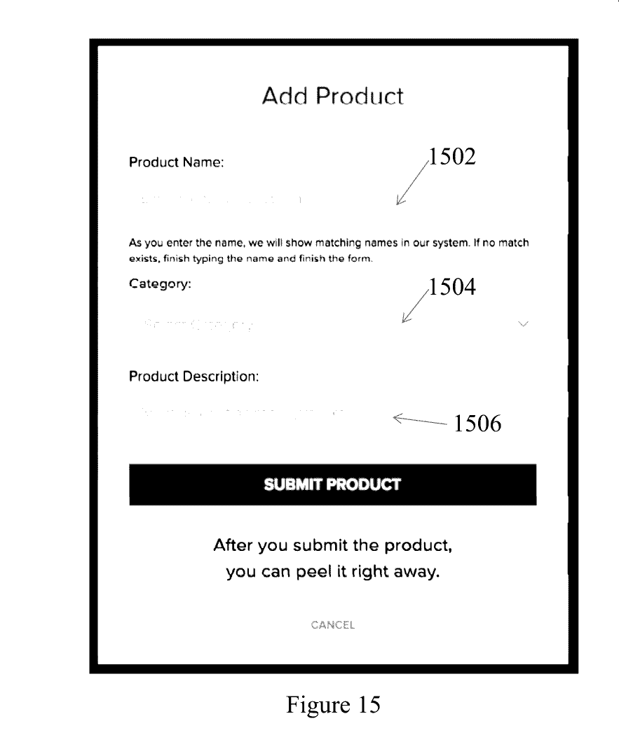

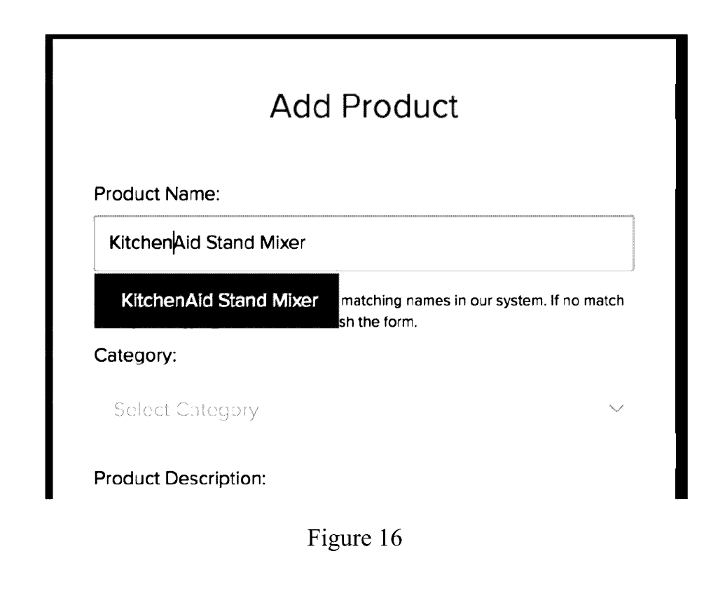

In some embodiments, the product review ranking and delivery system includes functionality that allows users to add products to be peeled into the system. This way, products that are searchable in the system can be determined (at least in part) by products that are of interest to users of the system. A new product can be added to the system by any logged-in user of the system. FIG. 14 shows a screenshot of an example homepage 1400 in which a user can click on an Add Product button 1402 to add a product, and FIG. 15 shows an example screenshot of adding a product. Referring to FIG. 15, a product name field 1502 solicits a response to identify the product being added, a product category field 1504 solicits a response to identify a category of the product being added, and a product description field 1506 solicits a response on a description of the product being added. Upon a user entering a name of the product being added (or other solicited response), the system can search for a match with an existing product in the system, including extended product listings from publishers and retailers. FIG. 16 shows an example screenshot of matching a user entered product name with that of an existing product in the system. If the system identifies a match, the system can direct the user to a product page of the matching product, so the user can contribute a peel of the matching product. On the other hand, if a matching product is not identified and an associated product page is not yet created, the system can create a product page based on solicited responses provided by the user and by accessing an Experience Engine and its associated application programming interface (API). The system can account for multiple potential matches to company and product names to reduce the potential for creation of redundant product pages.

In some embodiments, a product review ranking and delivery system ranks feedbacks, or peels of products, and determines and selects which feedbacks to display to a particular user based on relevance to the user, where relevance can be determined based on multiple input variables aggregated and processed by an Experience Engine. For example, the Experience Engine can implement a ranking technique that allows identification and delivery of the most relevant feedbacks to a user that matches who the user is as a person and what the user has experienced with similar products or other products.

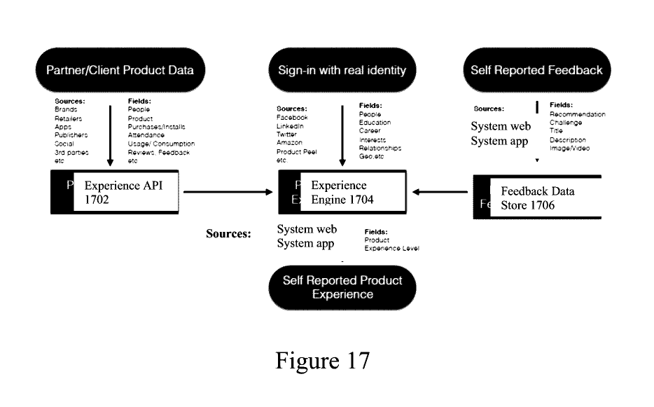

FIG. 17 is an example block diagram representation of functionality of a product review ranking and delivery system including an Experience Engine 1704 and a Feedback Data Store 1706.

As shown in FIG. 17, contributors' experiences on using products are submitted by and collected from third party entities, such as retailers, entities affiliated with product brands, social media sites, and publishers, through an Experience API 1702. Experiences can be collected as experience levels in terms of an extent of usage of products, whether a quantitative metric or other metric along a scale. In some embodiments, a software application can be installed by a contributor to monitor attendance, usage, or performance, and can convey monitored data on experience level to the Experience API 1702.

In addition, contributors' feedbacks on actual experiences on using products are submitted by and collected from users of the product review ranking and delivery system, through the Feedback Data Store 1706. Experiences can be collected in terms of one or more aspects of peeling a product in the form of components of product peels. As part of collecting feedbacks, the system can request that contributors identify themselves and provide context so that the system can identify other users who might share similar context. Context can include attributes regarding, for example, one or more of related or familiar people, demographics (e.g., age, gender, and so forth), education, career or profession (e.g., title, company, income, and so forth), interests, relationships, geography (e.g., residence or work), related or other products previously used, experiences and experience levels on related or other products previously used, and so forth. The Feedback Data Store 1706 aggregates and processes collected feedback for access and ranking to be performed by the Experience Engine 1704. In addition to feedbacks on product experiences, the Feedback Data Store 1706 also can aggregate and process collected experiences on using products, such as collected through the Experience API 1702.

Still referring to FIG. 17, the Experience Engine 1704 allows a user access to feedbacks on a product, which are organized as product peels. As part of accessing feedbacks, the Experience Engine 1704 can request that the user identify himself or herself and provide context so that the Experience Engine 1704 can identify feedbacks from contributors who might share similar context. Identification of the user and collection of context can be attained directly through the Experience Engine 1704, or by signing or logging in a third party site. It is contemplated that context submitted by the user can be stored and linked with the user for subsequent retrieval by the Experience Engine 1704, such that the user can omit providing context when subsequently accessing the Experience Engine 1704.

The Experience Engine 1704 ranks feedbacks, or peels of products, and determines which feedbacks to display to a user based on relevance to the user. In some embodiments, the Experience Engine 1704 implements a ranking technique that determines what experiences are more likely for the user, and where an experience that is more likely for the user can be based on feedback from others who are similar to the user, and an experience level that the user is likely to have with a product of interest. The ranking technique directs the calculation of the user's Experience Score for each feedback from another person being ranked, which is a relevance score of how likely is the user to share a similar experience as the feedback from the other person. Then, the ranking technique uses calculated Experience Scores for various feedbacks to determine which feedbacks are displayed to the user. For example, most, or all, feedbacks can be displayed in a ranked order according to their respective Experience Scores, a selected subset of feedbacks having Experience Scores at or above a minimum threshold can be displayed, the top N feedbacks according to their Experience Scores can be displayed, where N is 1, 2, 3, 4, 5, or more, and so forth.

In some embodiments, calculation of a user's Experience Score can be represented as follows:

Experience Score for a particular feedback from another person=Relevancy+Possible Experience+Feedback Weight+Timeliness

In the above formula:

Relevancy is a metric, such as a number between 1 and 10, which measures how similar the person that contributed the feedback is to the user, where feedbacks from persons of greater similarity to the user can be assigned a higher value for Relevancy, and feedbacks from persons of lesser similarity to the user can be assigned a lower value for Relevancy. This metric can be determined by the number of matching contextual attributes between the user and persons that contributed feedbacks, such as, for example, demographics, geography, relationships, profession, and other contextual attributes. Additionally, Relevancy also can be determined by interactions and expected interactions of persons similar to the user with the feedback or other similar feedback. For example, a feedback from a person with three matching contextual attributes to the user, such as age, gender, and geography, can be assigned a lower value for Relevancy than a feedback from a person with five matching contextual attributes to the user, such as age, gender, geography, title, and company. In some embodiments, the Experience Engine 1704 implements a machine learning technique to identify, for each user, which respective contextual attributes are more effective at establishing Relevancy for that user instead of other contextual attributes, and the Experience Engine 1704 assigns higher weights to those identified attributes for that user. For example, contextual attributes of age, gender, and geography can be identified as more effective at establishing Relevancy for a first user, and Relevancy of a feedback contributed by a person can be determined for the first user by the number of matches between the first user and the person with respect to the contextual attributes identified for the first user (age, gender, and geography), while contextual attributes of age, geography, title, and company can be identified as more effective at establishing Relevancy for a second user, and Relevancy of a feedback contributed by a person can be determined for the second user by the number of matches between the second user and the person with respect to the contextual attributes identified for the second user (age, geography, title, and company). Effectiveness of contextual attributes at establishing Relevancy can be determined by monitoring a user's interactions with feedbacks (and identifying matching contextual contributes between the user and persons who contributed those feedbacks) and by the user's own contributed feedback for a product (and identifying matching contextual contributes between the user and persons who contributed feedbacks for the same product).

Possible Experience is a metric, such as a number between 1 and 10, which measures how likely is the user to share the same experience (or the same experience level) as the feedback on a product being ranked. This metric can be determined by the number of matching contextual attributes between the user and persons that share a certain type of experience (e.g., a positive experience or a negative experience) on using the product. A recommendation status can be incorporated into this metric that feeds into determination of Possible Experience. In some embodiments, the Experience Engine 1704 determines Possible Experience by identifying persons that have similar experiences with each product (and related products), and creates a product experience code for each product that represents common or shared contextual attributes and correlated product experiences of a group of persons that are having a certain type of experience (e.g., a positive experience or a negative experience) with each product. A data structure can be created in a relational or other database including an entry for a first product including shared contextual attributes of persons having a positive experience with the first product (e.g., recommended) and shared contextual attributes of persons having a negative experience with the first product (e.g., not recommended), an entry for a second product including shared contextual attributes of persons having a positive experience with the second product (e.g., recommended) and shared contextual attributes of persons having a negative experience with the second product (e.g., not recommended), and so on. In determining Possible Experience of a feedback indicative of a certain type of experience with a product, the Experience Engine 1704 compares contextual attributes of the user to a product experience code for the product and assigns a value to Possible Experience that is indicative of how similar the user is to the product experience code, or in order words, how similar the user is to persons who are having that type of experience with the product. For example, if the feedback is indicative of a positive experience with the product (e.g., recommended), Possible Experience of the feedback can be determined for the user by the number of matching contextual attributes between the user and persons having a positive experience with the product, where a higher value can be assigned to Possible Experience in the case of a greater number of matching contextual attributes, and a smaller value can be assigned to Possible Experience in the case of a smaller number of matching contextual attributes. Creation and processing of experience codes can be similarly extended to services, places, people, events, campaigns, and so forth.

Feedback Weight is a metric, such as a number between 1 and 10, which is assigned to the feedback based on a number of user interactions with the feedback, such as instances of voting, sharing, replying, and adding to the feedback, and so forth, where feedbacks with more interactions (e.g., more popular feedbacks) can be assigned a higher value for Feedback Weight, and feedbacks with less interactions (e.g., less popular feedbacks) can be assigned a lower value for Feedback Weight.

Timeliness is a metric, such as a number between 1 and 10, which measures how much time has elapsed since the feedback was contributed, where more recently contributed feedbacks can be assigned a higher value for Timeliness, and more dated feedbacks can be assigned a lower value for Timeliness.

Other representations of the formula for calculating a user's Experience Score are contemplated, such as where respective weighting parameters are assigned to the metrics (e.g., in range from 0 to 1), where the metrics are multiplied or otherwise combined in a manner other than, or in combination with, summation, where the metrics are further sub-divided, where one or more of the metrics are omitted, and so forth.

The product review ranking and delivery system of FIG. 17 provides a centralized hub for users to discover, contribute, and share product reviews with other similar persons. In addition, the system can leverage the Feedback Data Store 1706 and Experience Engine 1704 to provide recommendations of who a user should invite to peel a product of interest to the user, such that the user can obtain relevant feedback from persons that are most similar to the user. For example, an “Invite to Peel” request can be conveyed to a similar person, based on a recommendation provided by the system.

Furthermore, the system provides scalability to expand access to its functionality through third party entities, such as retailers, entities affiliated with product brands, and publishers both in web and mobile environments. Publishers, retailers, and brand-affiliated entities can integrate a widget or selected product peels at appropriate locations on their websites, mobile software applications, e-mails, and so forth. The system can ensure that most relevant consumer feedback peels are displayed to a potential buyer, thereby accelerating goals of a publisher, a retailer, or a brand.

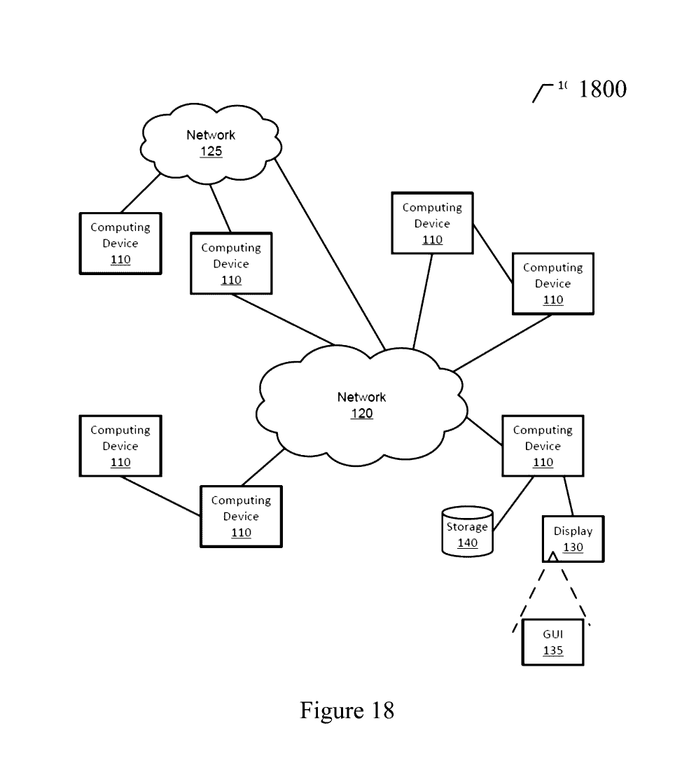

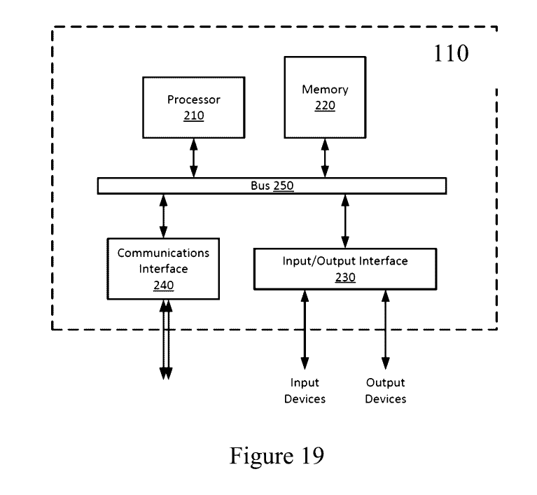

FIG. 18 is a representation of an example of a network environment 1800 in which the product review ranking and delivery system of some embodiments can be implemented. As shown, computing devices 110 may communicate with each other directly, through another computing device 110, through one network 120 or 125, or through a combination of networks 120, 125. Computing devices 110 are devices including a combination of hardware and software (including firmware and hard-wired software), in which processing circuitry such as a processor executes instructions that direct the processor to perform functionality. Computing devices 110 are described in more detail with respect to FIG. 19. Functionality of the product review ranking and delivery system of some embodiments can be implemented within one component shown in FIG. 18, or across multiple components shown in FIG. 18.

Networks 120, 125 each represent one or more public or private networks. For example, one of networks 120, 125 may represent a local area network (LAN), a home network in communication with a LAN, a LAN in communication with a wide area network (WAN) such as the Internet, a WAN, or other networks, or a combination of networks. Portions of one or more networks 120, 125 may be wired, and portions of one or more networks 120, 125 may be wireless. Further, networks 120, 125 may include one or more of telephone networks, cellular networks, or broadband networks. Communication through the networks 120, 125 may be made using standard or proprietary protocols suitable for the associated network.

One or more computing devices 110 in the network environment 1800 include a display 130 for displaying or otherwise providing information to a user of the computing device 110, and a graphical user interface (GUI) 135 for interaction with the user. Input devices (not shown) allow the user to input information for the user interaction. In some embodiments, display 130 is a touch screen display, and is correspondingly also an input device. Other examples of input devices include a mouse, a microphone, a camera, and a biometric detector.

One or more computing devices 110 in the network environment 1800 include an external storage 140, which represents one or more memory devices for storing information. Storage 140, for example, is a mass storage, and may include one or more databases. Storage 140 may be dedicated to one or more computing devices 110 (which may be co-located with storage 140 or in communication with storage 140 over one or more networks 120, 125), or may be non-dedicated and accessible to one or more computing devices 110 (locally or by way of one or more networks 120, 125).

FIG. 19 shows an example of computing device 110 that includes a processor 210, a memory 220, an input/output interface 230, and a communications interface 240. A bus 250 provides a communication path between two or more of the components of computing device 110. The components shown are provided by way of example and are not limiting. Computing device 110 may have additional or fewer components, or multiple of the same component.

Processor 210 represents one or more of a microprocessor, microcontroller, an application-specific integrated circuit (ASIC), and a field-programmable gate array (FPGA), along with associated logic.

Memory 220 represents one or both of volatile and non-volatile memory for storing information. Examples of memory include semiconductor memory devices such as erasable programmable read-only memory (EPROM), electrically erasable programmable read-only memory (EEPROM), random-access memory (RAM), and flash memory devices, discs such as internal hard drives, removable hard drives, magneto-optical, compact disc (CD), digital versatile disc (DVD), and Blu-ray discs, memory sticks, and the like.

The functionality of the product review ranking and delivery system of some embodiments can be implemented as computer-readable instructions in memory 220 of computing device 110, executed by processor 210.

Input/output interface 230 represents electrical components and optional instructions that together provide an interface from the internal components of computing device 110 to external components. Examples include a driver integrated circuit with associated programming.

Communications interface 240 represents electrical components and optional instructions that together provide an interface from the internal components of computing device 110 to external networks, such as network 120 or network 125 (FIG. 18).

Bus 250 represents one or more connections between components within computing device 110. For example, bus 250 may include a dedicated connection between processor 210 and memory 220 as well as a shared connection between processor 210 and multiple other components of computing device 110.

Some embodiments of this disclosure relate to a non-transitory computer-readable storage medium having computer code or instructions thereon for performing various computer-implemented operations. The term “computer-readable storage medium” is used to include any medium that is capable of storing or encoding a sequence of instructions or computer code for performing the operations, methodologies, and techniques described herein. The media and computer code may be those specially designed and constructed for the purposes of the embodiments of the disclosure, or they may be of the kind available to those having skill in the computer software arts. Examples of computer-readable storage media include those specified above in connection with memory 220, among others.

Examples of computer code include machine code, such as produced by a compiler, and files containing higher-level code that are executed by a processor using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computing device) to a requesting computer (e.g., a client computing device or a different server computing device) via a transmission channel. Another embodiment of the disclosure may be implemented in hardwired circuitry in place of, or in combination with, processor-executable software instructions.

While this disclosure has been described with reference to the specific embodiments thereof, it should be understood by those skilled in the art that various changes may be made and equivalents may be substituted without departing from the true spirit and scope of this disclosure as defined by the appended claims. In addition, many modifications may be made to adapt a particular situation, material, composition of matter, method, or process to the objective, spirit and scope of this disclosure. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of this disclosure. Accordingly, unless specifically indicated herein, the order and grouping of the operations are not limitations of this disclosure.

What is claimed is:

1. A system comprising:
a processor; and
a memory connected to the processor, the memory storing instructions executable by the processor to:
identify an access request by a user of a client device;
establish context of a feedback on a product or service;
determine a relevance of the feedback to the user based on the context of the feedback; and
select the feedback for delivery to the client device based on the relevance to the user.

2. The system of claim 1, wherein the instructions to establish the context of the feedback include instructions to identify attributes of a contributor of the feedback.

3. The system of claim 2, wherein the attributes of the contributor include at least one of demographics, education, profession, interests, relationships, or geography of the contributor.

4. The system of claim 1, wherein the feedback is indicative of a positive or negative experience with the product or service, and the instructions to establish the context of the feedback include instructions to identify shared attributes of persons who have the same experience with the product or service.

5. The system of claim 1, wherein the instructions to establish the context of the feedback include instructions to identify a timeliness of the feedback.

6. The system of claim 1, wherein the instructions to establish the context of the feedback include instructions to identify a number of user interactions with the feedback.

7. The system of claim 1, wherein the memory further stores instructions executable by the processor to establish context of the user, and the instructions to determine the relevance of the feedback include instructions to calculate a relevance score based on matching the context of the user and the context of the feedback.

8. The system of claim 1, wherein the memory further stores instructions executable by the processor to deliver the feedback for display at the client device, and the feedback includes at least one of an image, audio, a video, or text.

9. The system of claim 8, wherein the feedback includes a sequenced set of slides viewable by the user in response to triggering a navigation element.

10. The system of claim 9, wherein the sequenced set of slides includes a first slide and a second slide, and the second slide is displayed in place of the first slide in response to triggering the navigation element.

11. The system of claim 10, wherein the navigation element is a forward navigation element, and the first slide is displayed in place of the second slide in response to triggering a backward navigation element.

12. The system of claim 1, wherein the memory further stores instructions executable by the processor to:
establish permission to the user to add content to the feedback; and
incorporate additional content contributed by the user into the feedback.

13. The system of claim 1, wherein content of the feedback is editable by a contributor of the feedback.

14. The system of claim 1, wherein the memory further stores instructions executable by the processor to:
establish context of a reply to the feedback contributed by the user; and
establish a link between the feedback and the reply.

15. A system comprising:
a processor; and
a memory connected to the processor, the memory storing instructions executable by the processor to:
identify an access request by a client device; and
deliver a feedback on a product or service for display at the client device, the feedback includes a recommendation status, a set of navigation elements, and a sequenced set of slides viewable in response to triggering the set of navigation elements.

16. The system of claim 15, wherein the set of navigation elements includes a forward navigation element, the sequenced set of slides includes a first slide and a second slide, and the second slide is displayed in place of the first slide in response to triggering the forward navigation element.

17. The system of claim 16, wherein the set of navigation elements further includes a backward navigation element, and the first slide is displayed in place of the second slide in response to triggering the backward navigation element.
